(19) United States
(12) Patent Application Publication
(10) Pub. No.: US 2003/0134733 A1
(43) Pub. Date: Jul. 17, 2003

(54) Multi-size box erector

(76) Inventor: Johnnie W. Thompson, Pelzer, SC (US)

Correspondence Address: Cort Flint, McNAIR LAW FIRM, P.A., P.O. Box 10827, Greenville, SC, 29603-0827, US

(21) Appl. No.: 10/044,023

(22) Filed: Jan. 11, 2002

(51) Int. Cl. B31B 49/00

(52) U.S. Cl. 493/51

(57) ABSTRACT

A box erector of the type having a closure section and an exit section is provided for producing open boxes having taped bottom flaps. The box erector includes a main frame with a closure frame of the closure section carried by the main frame, a taping frame of the closure section carried by the main frame, and an exit frame of the exit section carried by the main frame. The closure frame includes an adjustable closure frame member, the taping frame includes an adjustable taping frame member, and the exit frame includes an adjustable exit frame member. An adjusting mechanism is provided for adjusting the adjustable closure frame member, taping frame member, and exit frame member, whereby an adjustable box erector capable of receiving a variety of differently sized boxes is provided that can be utilized as an adjunct to an existing product packaging system.

### FIELD OF THE INVENTION

This invention is directed to a box erector for erecting cardboard boxes from a flat folded condition, and more specifically, to erecting cardboard boxes of different sizes on the same machine.

### BACKGROUND OF THE INVENTION

Heretofore, box erector apparatus have been proposed for setting up folded carton or box planks, closing their bottom flaps, and sealing the bottom flaps so that the box may be loaded. For example, see U.S. Pat. Nos. 4,579,551; 4,348,853; 5,156,582; and Re27,631. Pat. No. Re 27,631 discloses a box erector, which utilized suction for grasping portions of the folded carton during erection, and various actuators for closing the end and side flaps. While apparatus have been previously proposed for automatically erecting boxes, they have not been entirely suitable, particularly, as an adjoining operation to an existing product line whereby boxes can be erected and fed to a feeding system for filling of the boxes with packaged products and the like. In addition, the prior box erectors have been unnecessarily complicated in construction, and have required large amounts of floor space. This has made them particularly unsuitable for unitization in existing floor space as an adjunct to an existing product line for erecting the boxes to be filled at the product line in conjunction with the manufacturing of products.

U.S. Pat. No. 5,156,582, discloses a box erector with improvements in reducing the size of the machine for use with existing floor space and product manufacturing lines. However, the invention lacks the ability to easily and quickly adapt to different box sizes. Often, manufactures have a product line with variations that require multiple box sizes. Many of these manufactures have a total box volume that justifies purchasing a box erector, but not a separate erector for each different box size. Thus, there is a need for a single box erector machine capable of easily accommodating different box sizes.

Accordingly, an object of the present invention is to provide a box erector having a small footprint, which can be utilized without modification with an existing product feeding system.

Another object of the present invention is to provide a compact box erector that is simple, yet reliable, and can be utilized as an adjunct to an existing product feeding system for boxing of the product.

Another object of the present invention is to provide a box erector capable of quickly and easily adjusting to accommodate different box sizes without complicated alteration to the box erector machine.

### SUMMARY OF THE INVENTION

The above objectives are accomplished according to the present invention by providing a box erector for erecting folded boxes of different sizes into open boxes having a rectangular form. Each of the open boxes having a pair of side panels and a pair of end panels, a pair of bottom end flaps and bottom side flaps, and a pair of top end flaps and top side flaps. The box erector being of the type having a closure section and an exit section, wherein a feed opening is provided at the closure section and a delivery zone is provided at the exit section. The box erector includes a main frame with a closure frame of the closure section carried by the main frame, a taping frame of the closure section carried by the main frame, and an exit frame of the exit section carried by the main frame.

An adjustable shuttle assembly is carried by the main frame adjacent the closure section for receiving the folded boxes. The shuttle assembly opens the folded boxes into open boxes and transferees the open boxes to the closure frame at the feed opening in the closure section. The shuttle assembly includes a box receiving table being adjustable to align different box sizes on the box receiving table for feeding to the closure frame.

The closure frame receives the open boxes for closing the bottom side and end flaps to produce open boxes with closed bottom flaps. The taping frame receives the open boxes with closed bottom flaps for taping the bottom flaps to produce completed taped boxes having closed, taped, bottom flaps, but open top flaps so the box can be filled. The exit frame receives the completed taped boxes and delivers the boxes to the delivery zone where the boxes are ready for filling.

The closure frame includes an adjustable closure frame member, the taping frame includes an adjustable taping frame member, and the exit frame includes an adjustable exit frame member. A box size adjusting mechanism is provided for adjusting the adjustable closure frame member, taping frame member, and exit frame member according to the box size being processed, whereby an adjustable box erector capable of receiving a variety of differently sized boxes is provided that can be utilized as an adjunct to an existing product packaging system.

In the preferred embodiment, the box receiving table includes a tilt table for supporting the folded boxes for opening and transfer to the closure frame. The tilt table has a box receiving position in which the tilt table is raised vertically along the shuttle frame and tilted for receiving the folded boxes, and a box depositing position in which the tilt table is retracted and lowered along the shuttle frame for delivering the boxes to the closure frame. A shuttle drive is operatively associated with the tilt table for moving the tilt table between the box receiving position and the box depositing position. The shuttle drive includes a first actuator raising and lowering the tilt table vertically along the shuttle frame for depositing the open boxes in the closure frame, and a second actuator tilting and retracting the tilt table to receive the folded boxes.

In a further advantageous embodiment, the closure frame, taping frame and exit frame are sequentially aligned along a longitudinal conveyance path of the open boxes during processing. The adjustable closure frame member, adjustable taping frame member, and adjustable exit frame member are provided by a common adjustable longitudinal rail which extends along a common side of the closure frame, taping frame and exit frame. The adjustable longitudinal rail is operatively associated with the box size adjusting mechanism to adjust the width of the closure frame, taping frame and exit frame to a specific box size being processed.

In the preferred embodiment, the adjusting mechanism includes a main adjustment bar carried by the main frame with a first set of adjusting linkages carried by the main adjustment bar being connected to the longitudinal movable rail for moving the longitudinal movable rail to adjust the width of the closure frame, taping frame, and exit frame. The closure frame further includes end flap folding members for closing the bottom end flaps and the taping frame including a tape applicator carried by a movable taping carriage for taping the bottom end and bottom side flaps closed after folding. A second set of adjusting linkages carried by the main adjustment bar is connected to the end flap folding members and the movable taping carriage for adjusting the centerline position of same to accommodate folding and taping different box sizes. The first set of adjusting linkages moves at a two to one ratio to the second set of adjusting linkages.

In an advantageous embodiment, a box conveyor is provided for moving the open boxes through the closure frame, taping frame and exit frame, and maintaining proper orientation of the boxes during folding and taping. The box conveyor includes an engaging member for engaging at least one of the bottom end and bottom side flaps during taping. The adjusting mechanism is operatively associated with the engaging member for adjusting the position of the engaging member in conjunction with the closure section to accommodate closing and taping different box sizes. The box conveyor including a pressure foot assembly which includes a pressure foot that constitutes the engaging member. The pressure foot extends into the open boxes during folding by the closure section for applying pressure to the inner surface of the bottom end and bottom side flaps. The pressure foot assembly is carried on a pressure foot frame which is carried above the closure section. An adjusting mechanism is operatively associated with the pressure foot for moving the pressure foot when folding different box sizes to apply pressure over a centerline position along which the boxes are taped.

Preferably, the pressure foot assembly includes first and second mounts slidably carried by the pressure foot frame for supporting the pressure foot assembly within the pressure foot frame. A box conveyance path is defined between the mounts along which the pressure foot moves the open boxes through the closure frame, taping frame and exit frame. The adjusting mechanism is connected to the first and second mounts for moving the pressure foot assembly transverse to the box conveyance path to adjust the position of the pressure foot to the centerline position for a specific box size. As with the closure section adjusting mechanism, the adjusting mechanism for the box conveyor includes a main adjustment bar carried by the main frame and a set of adjusting linkages carried by the main adjustment bar being connected to the first and second mounts so that when the main adjustment bar is rotated, the adjusting linkages move the pressure foot assembly in the transverse direction to the box conveyance path to position the pressure foot at the correct centerline location for different box sizes.

### DESCRIPTION OF THE DRAWINGS

The construction designed to carry out the invention will hereinafter be described, together with other features thereof.

The invention will be more readily understood from a reading of the following specification and by reference to the accompanying drawings forming a part thereof, wherein an example of the invention is shown and wherein:

FIG. 1 shows a perspective view of the box erector according to the invention;

FIG. 2 shows a side view of the shuttle section according to the invention;;

FIG. 2A shows a side view of the shuttle section with the tilt table in a tilted box receiving position according to the invention;

FIG. 3 shows a front view of the shuttle section according to the invention;

FIG. 4 shows a top view of the shuttle section according to the invention;

FIG. 5 shows a cutaway top view of the closure section and exit section according to the invention;

FIG. 5A shows a cutaway top view of the closure section and exit section in an extended position to accommodate a different box size according to the invention;

FIG. 6 shows a cross section view of the closure section detailing the adjusting mechanism according to the invention;

FIG. 7 shows a cross section view of the closure section detailing the adjusting mechanism and closure assembly according to the invention;

FIG. 8 shows a cutaway side view of the box erector according to the invention;

FIG. 9 shows a top view of the pressure foot section according to the invention; and,

FIG. 10 shows an end side view of the pressure foot section detailing the adjusting mechanism according to the invention.

### DESCRIPTION OF A PREFERRED EMBODIMENT

Referring now to the drawings, the invention will be described in more detail. U.S. Pat. No. 5,156,582, incorporated herein by reference, discloses the components of a box erector machine on which the present invention is based. The present invention, however, incorporates a new box loading system and adjusting mechanism for moving selected hardware components which allows the box erector to accommodate a size range of boxes.

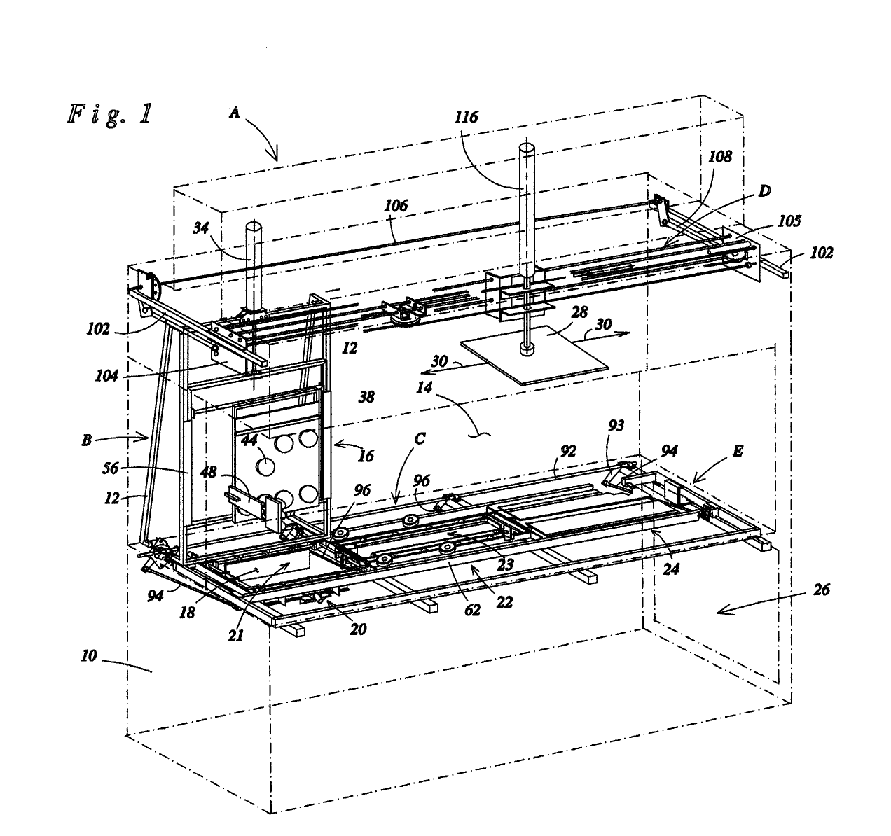

Referring to FIG. 1, a preferred embodiment of a box erector A is shown having three basic sections: a shuttle section, designated generally as B, for receiving and opening a folded box; a closure section, designated generally as C, for closing and taping the open box flaps to provide a completed box form; and a box conveyor section, designated generally as D, for moving the open box through the closure section and maintaining proper orientation of the box during folding and taping. The box erector includes a main frame 10 with various vertical and horizontal frame elements for supporting the shuttle, closure and pressure foot sections within the main frame. The main frame arrangement may vary according to the factory floor layout in order to fit with existing product packaging equipment, especially the location of where the competed folded box is delivered from the erector. In the preferred embodiment, the erector is designed for use with a 10×10×10 to 15×15×15 box range, having a footprint of 36″×74″×94″.

Each folded box is commonly made from paperboard and includes a pair of spaced apart side panels, a pair of spaced apart end panels, a pair of bottom end flaps, a pair of bottom side flaps, and a pair of top end flaps and a pair of top side flaps. The erector folds the bottom end and side flaps inward for closure and then taps the flaps to close the bottom of the box. The top end flaps and top side flaps remain open in the unfolded position so that the box can be filled with products. In order to adapt the box erector to fold various box sizes, each section (shuttle, closure and box conveyor) is provided with an adjusting mechanism to adjust the section to fold a specific box size. Each section and its associated adjusting mechanism will be described in detail below.

First, an overview of the box erector A is shown in FIG. 1, the shuttle section in general receives the folded box through an entrance zone 14 of main frame 10 and unfolds the box to produce an open box ready for closure. After the box is opened, it is lowered into closure section C for closing and taping of the bottom end and side flaps. A shuttle frame 12 is included in the shuttle section and is carried by main frame 10. A shuttle assembly, designated generally as 16, is carried by the shuttle frame adjacent to closure section C which performs the opening of the folded box and transferring of the open box into closure section C at a feed opening 18. Shuttle assembly 16 is slidably carried on shuttle frame 12 to move the shuttle assembly vertically along the shuttle frame between a raised box receiving position and a lowered box deposition position where the shuttle assembly lowers the open box into feed opening 18 of closure section C. In the preferred embodiment, the adjusting mechanism for the shuttle section is carried by the shuttle assembly for aligning different box sizes before entering the closure section, as is described in detail below.

Once the open box is lowered into closure section C the bottom end and bottom side flaps are folded inward to a closed position for taping. In the preferred embodiment, the closure section includes a closure frame, designated generally as 20, carrying a closure assembly, designated generally as 21, for closing the box flaps. The closure section also includes a taping frame, designated generally as 22, carrying a taping assembly, designated generally as 23, for taping the box flaps closed. It is preferable to include an exit section, designated generally as E, having an exit frame, designated generally as 24, following the closure section to control delivery of completed boxes through delivery zone 26. In order to fold different size boxes, the closure section and exit section also includes an adjusting mechanism to increase or decrease the width of the sections to accommodate different box size. When the width is adjusted, the adjusting mechanism further adjusts the location of the closure assembly and taping assembly to a designated centerline position along which the bottom flaps of a specific box size are taped closed, as described below.

Preferably, box conveyor section D is carried by main frame 10 above closure section C and exit section E. A pressure foot 28 is included in the box conveyor section which is lowered into the box interior. The pressure foot moves along a box conveyance path 30 to move the box through the closure section to the exit section, and applies pressure to the box flaps as the flaps are taped closed. In the preferred embodiment, the box conveyor section also includes an adjusting mechanism to move the pressure foot to the correct centerline position with the closure and taping assemblies when the closure section is adjusted to folded a different box size.

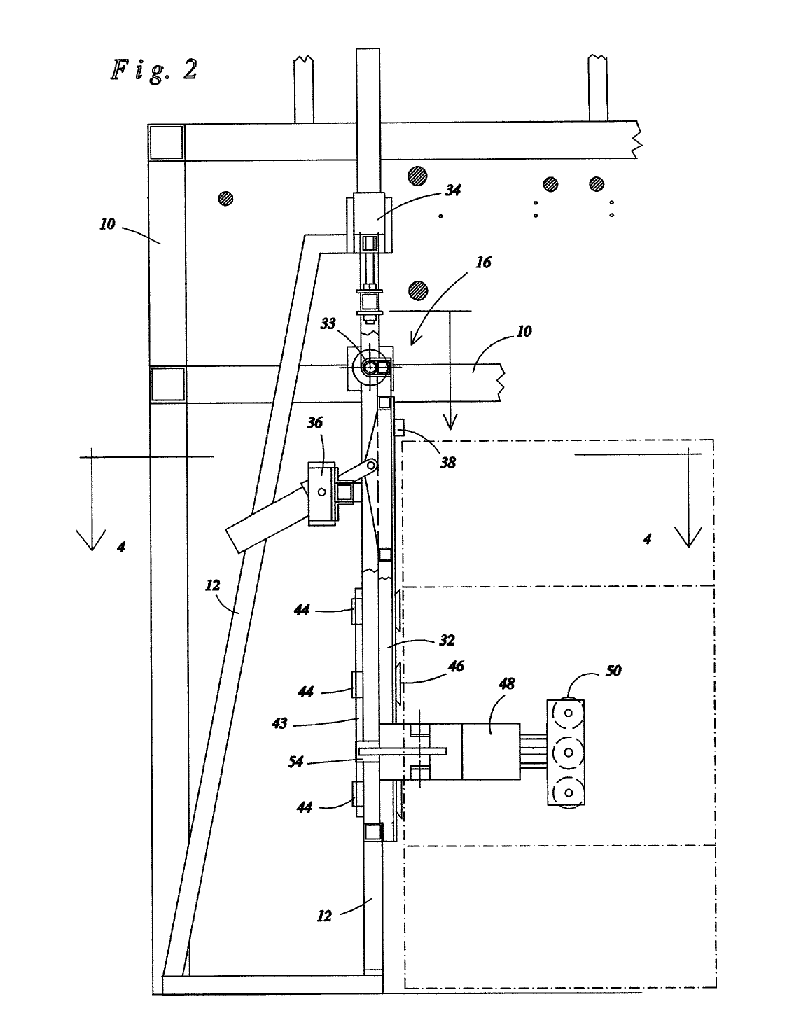

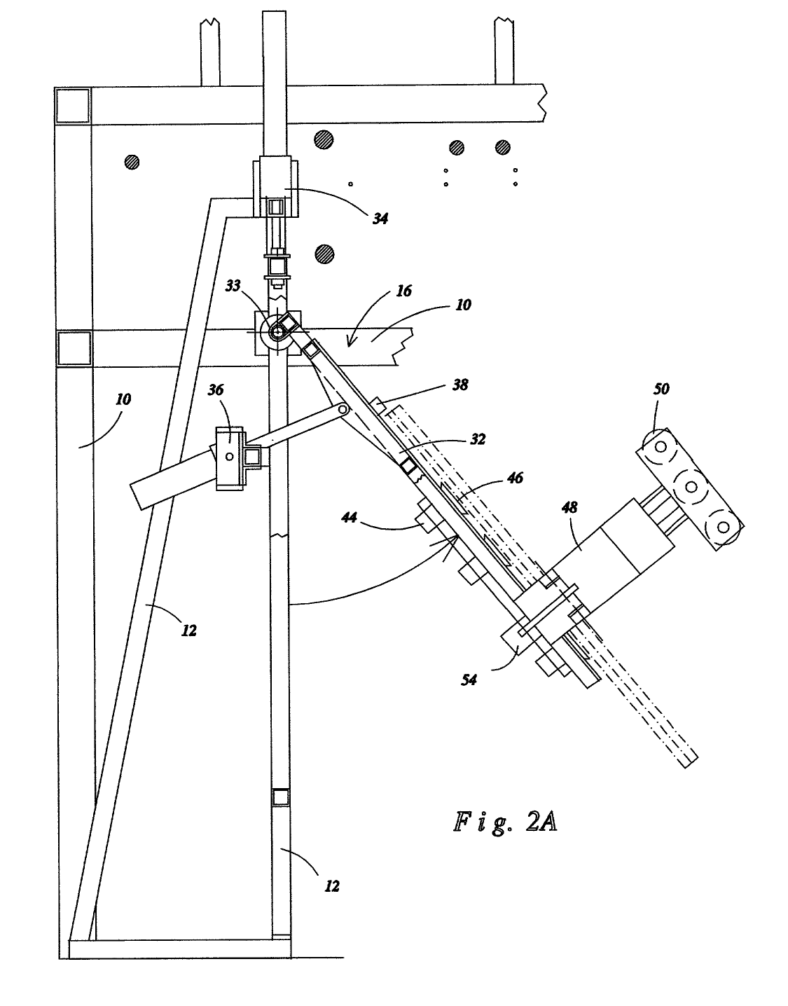

Referring in detail to shuttle section B, as shown in FIG. 2, the shuttle assembly includes a box receiving table 32 on which the folded box is placed in the shuffle assembly. In the preferred embodiment, the box receiving table is a tilt table for supporting the folded boxes for opening and transfer to said closure section. The tilt table has a box receiving position, as shown in FIG. 2A, in which the tilt table is raised vertically along said shuttle frame and tilted for receiving the folded boxes, and a box depositing position, as shown in FIG. 2, in which the tilt table is retracted and lowered along said shuttle frame for delivering the boxes to the closure section. The tilt table is carried by a pivoting bar 33 within the shuttle assembly which allows the tilt table to move between an approximately 45° angle for receiving a box and a near vertical position for deposition the box into the closure section.

A shuffle drive is operatively associated with the tilt table for moving the tilt table between the box receiving position and the box depositing position. Preferably, the shuttle drive includes a first actuator 34 raising and lowering the tilt table vertically along the shuttle frame for depositing the open box in the closure section, and a second actuator 36 for tilting and retracting the tilt table to receive the folded boxes. In the preferred embodiment, the first and second actuators are pneumatic cylinders operable between an extended position where the tilt table is lowered along the shuttle frame and the tilt table is tilted to receive the folded box, and a retracted position where the tilt table is raised along the shuttle frame and the tilt table is moved to the box deposition position.

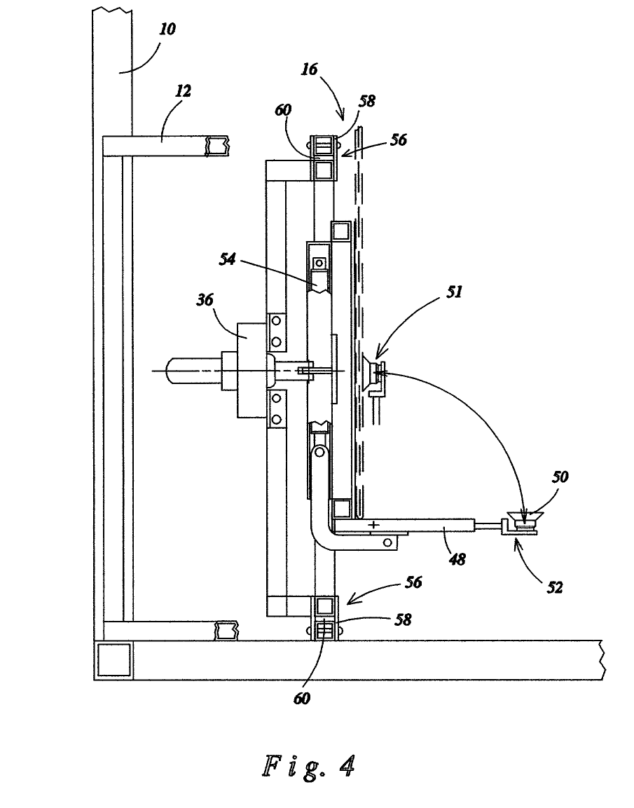

In an advantageous embodiment best shown in FIG. 4, a bracket 56 is provided for slidably attaching shuttle assembly 16 to shuttle frame 12. Plastic bearings 58 are disposed between the bracket and shuttle frame to allow for ease of movement by reducing friction along the shuttle frame. In combination with the plastic bearings, a plastic strip 60 is provided between the shuttle assembly and the shuttle frame along which the shuttle assembly glides to help facilitate ease of movement between the box receiving position and box deposition position.

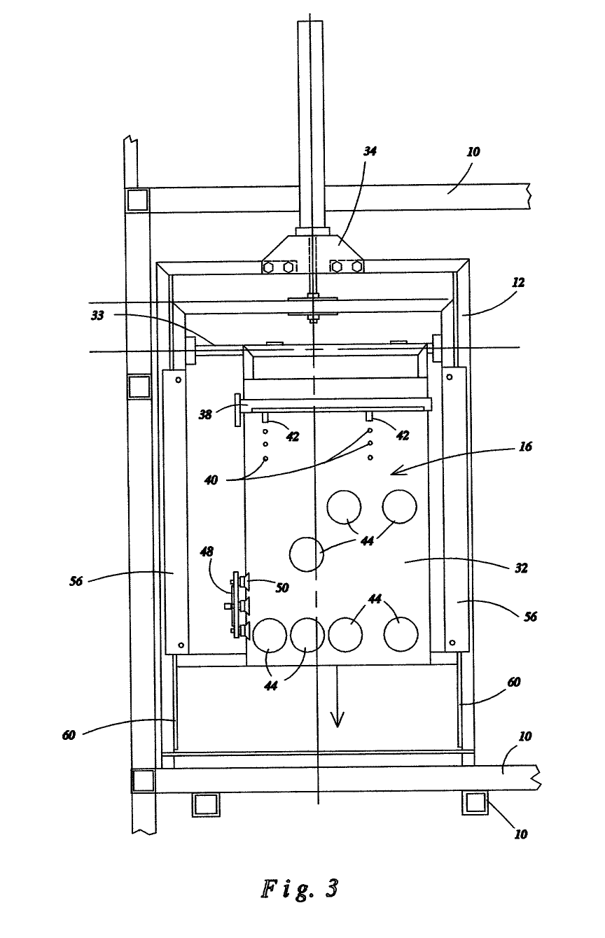

In the preferred embodiment, the adjusting mechanism is carried by the box receiving table for adjusting the position of the folded boxes on the box receiving table depending on the size of the box to be processed, so that the box is properly aligned when lowered into the closure section for closure and taping of the bottom side and bottom end flaps of the box. Referring to FIG. 3, the adjusting mechanism includes a gauge 38 carried by the box receiving table for aligning the folded boxes on the box receiving table according to the specific box size. An index is carried by the box receiving table for determining proper placement of the gauge on the box receiving table to properly position the folded box on the box receiving table. The gauge is, more specifically, a flap gauge against which the edges of the top box flaps abut to determine correct alignment on the box receiving table. Preferably, the flap gauge shown in FIG. 3 is an elongated bar extending across the box receiving table for abutting edges of the top box flaps, and the index includes a plurality of indexing elements 40 carried by the box receiving table that correspond to different box sizes. To secure the elongated bar in position, the bar includes complementary engagement elements 42 for engaging the indexing elements to correctly position the bar on the box receiving table for a specific box size to be processed.

Box receiving table 32 further includes a plurality of retention members for holding the folded box firmly against the box receiving table while the folded box is opened and transferred into the closure section. The retention members provide a suction force between the folded box and the box receiving table to hold the folded box in position for opening and transfer. In the preferred embodiment, the retention members include vacuum cups 44 carried by the box receiving table providing a suction to hold the folded box against the box receiving table. As shown best in FIG. 2, the vacuum cups include a lip portion 46 protruding through openings in the box receiving table and extending slightly above the surface of the box receiving table for holding the folded box. Preferably, the vacuum cups are carried by a mounting frame 43 attached to the underside of the tilt table, which allows for a plurality of vacuum cups to be spaced underneath the tilt table.

Referring to FIG. 4, in a further advantageous embodiment, the box receiving table also carries an opening arm 48 for engaging the folded boxes and opening the folded box into open boxes. The opening arm includes gripping elements 50 grasping the folded box for opening and a box gripping position, designated generally as 51, where the gripping elements grasp the folded box. Preferably, the gripping elements include vacuum cups disposed along a distal end of the opening arm for grasping the folded box. The opening arm also has a box opening position, designated generally as 52, where the arm is moved to unfold the folded box. An arm actuator 54 is provided for moving the opening arm between the box gripping position and the box opening position. Preferably, the arm actuator includes a pneumatic cylinder operable between an extended position where the opening arm is moved to the box gripping position, and a retracted position where the opening arm is moved to unfold the folded box.

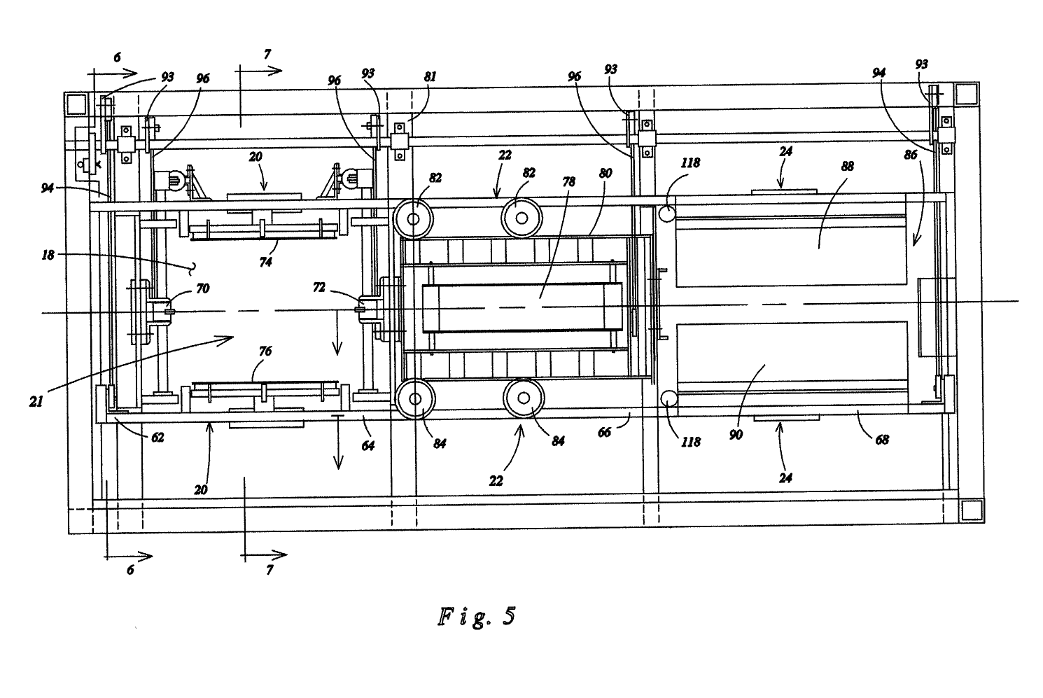

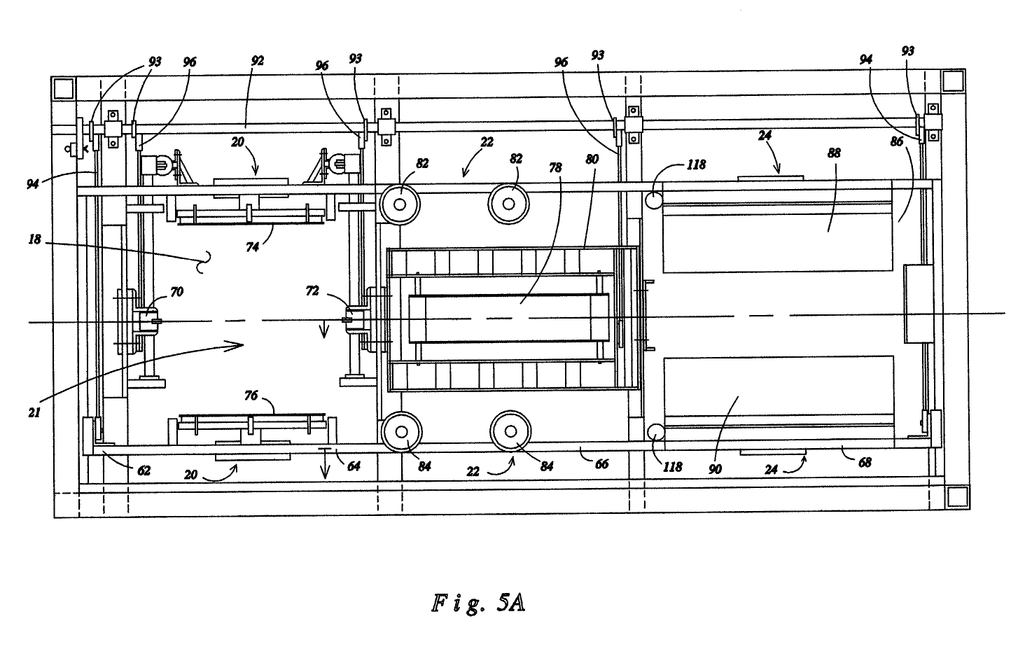

Referring now to closure section C, as best shown in FIG. 5, the closure section includes closure frame 20 carried by main frame 10 and taping frame 22 carried by main frame 10. Advantageously, the adjusting mechanism for closure section C and exit section E is operatively associated with the closure frame and taping frame for adjusting the width of the closure and taping frames according to the size of box being processed.

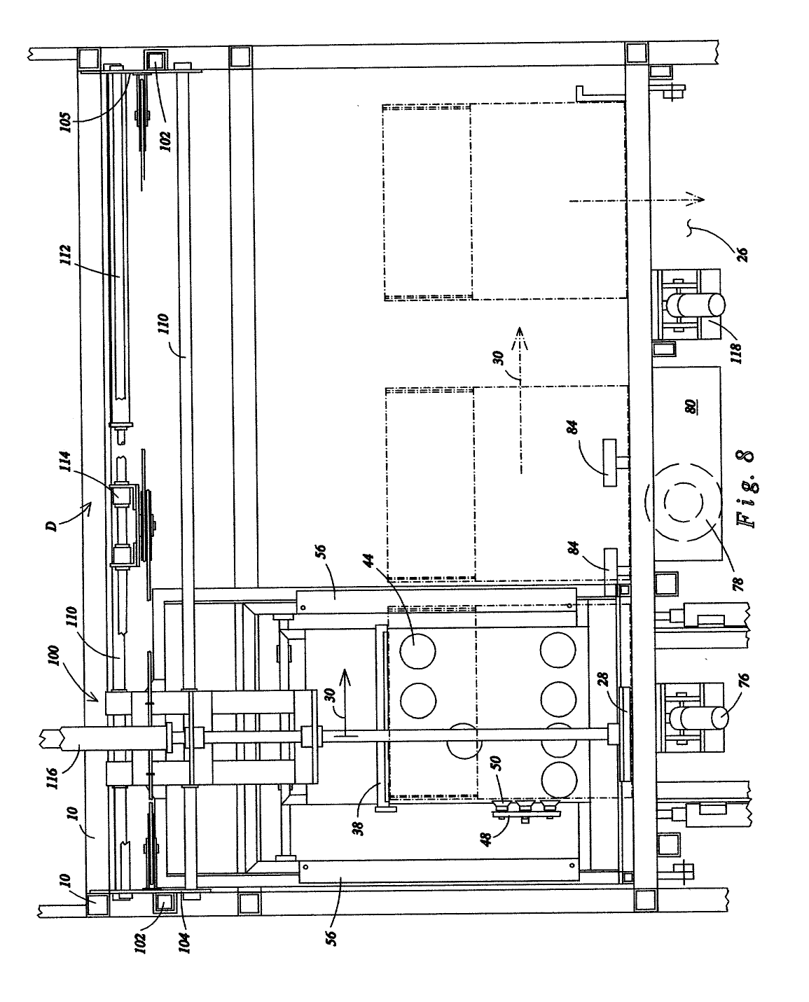

In order to make the closure and taping frames adjustable, a longitudinal movable rail 62 is provided that is operated by the adjusting mechanism. In the preferred embodiment, longitudinal movable rail 62 extends through the closure, taping and exit frames to provide an adjustable closure frame member 64, an adjustable taping frame member 66, and an adjustable exit frame member 68 to adjust the width of the closure section and exit section simultaneously for a specific box size to be processed. As best shown in FIG. 8, the boxes being folded move along box conveyance path 30 through the closure section for flap folding and taping and into the exit section. As shown in FIG. 5, rail 62 is disposed parallel to conveyance path 30 and is moveable transverse to the conveyance path by the adjusting mechanism to adjust the width of closure, taping and exit frame members 64, 66, and 68 for accommodating different box sizes.

Referring to FIG. 1, closure section C includes closure assembly 21 shown in FIG. 1. As best shown in FIG. 5, the closure assembly includes end flap folding members 70 and 72 for closing the bottom end flaps inward. The closure assembly also includes side flap folding members 74 and 76 for closing the bottom side flaps inward. A first of the side flap folding members 74 is affixed to closure frame 20, and a second of the side flap folding members 76 is carried by adjustable closure frame member 64 to adjust the width between first and second side flap folding members to accommodate the width of different box sizes. End flap folding members 70 and 72 are simultaneously moved by the adjusting mechanism to a centerline position along which the bottom side flaps of a specific box size are taped close. As best shown in FIG. 7, pneumatic cylinders 73 and 75 are provided for moving the end flap folding members and side flap closing members inward for closure. To move the end flap folding members, a rotatable rod 77 is used to connect cylinder 73 to end flap folding members 70 and 72.

Closure section C includes taping assembly 23. The taping assembly includes a tape applicator 78 carried by a movable taping carriage 80 for taping the bottom end and bottom side flaps closed as the box is passed over the tape applicator. To provide the adjustability to accommodate different box sizes, the taping carriage is moveable by the adjusting mechanism to adjust the centerline position of the taping carriage for taping along the centerline for a specific box size when the width of said taping assembly is adjusted to process a different box sizes. Fixed guide rollers 82 are carried by taping frame 22 for engaging a first side panel of the box to guide the box though the taping assembly. Movable guide rollers 84 engaging a second side panel of the box so that the box passes between the fixed and movable guide rollers. Movable guide rollers 84 are carried by adjustable taping frame member 66 for adjusting the width between the fixed and movable guide rollers to accommodate different box sizes.

In the preferred embodiment, exit section E carried by main frame 10 follows closure section C and includes exit frame 24 carrying an exit assembly, designated generally as 86. The exit assembly holds the completed box in an upright orientation before entering delivery zone 26 (FIG. 1). The longitudinal movable rail extending through the exit frame to provide the adjustable exit frame member that allows the adjusting mechanism to adjusting the width of the exit frame concurrently with the closure and taping frames so that different box sizes can pass through the exit frame. The exit assembly includes a first exit door 88 affixed to exit frame 24, and a second movable exit door 90 carried by the longitudinal movable rail for adjusting the width of the exit assembly. The first and second exit doors opening and closing to allow the completed box to pass from the exit assembly to delivery zone 26 where the box is ready to be filled.

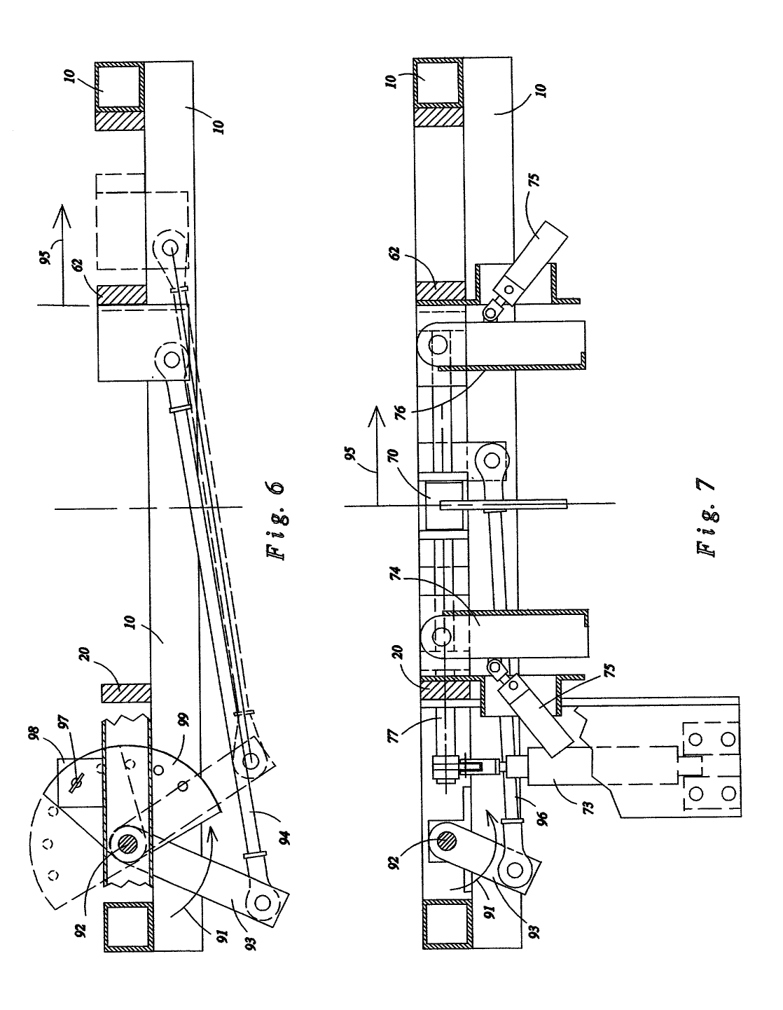

Referring to FIG. 5, the adjusting mechanism for adjusting the closure and exit sections includes a main adjustment bar 92 carried by main frame 10. A first set of adjusting linkages 94 is carried by main adjustment bar 92 and connected to longitudinal movable rail 62 for moving the longitudinal movable rail transverse to box conveyance path 30 to adjust the width of closure frame 20, taping frame 22, and exit frame 24. A second set of adjusting linkages 96 is carried by the main adjustment bar and connected to end flap folding members 70 and 72, and connected to movable taping carriage 80 for adjusting the centerline position of same to accommodate folding and taping different box sizes. In order to properly position the end flap folding members and taping carriage to the centerline position, the first set of adjusting linkages moves at a two to one ratio to the second set of adjusting linkages, which is the standard variation ratio for different box sizes. First set of adjusting linkages 94 is best shown in FIG. 6 being attached to longitudinal movable rail 62. Connecting arm 93 is affixed to main adjustment bar 92 at a first end and pivotally connected to adjusting linkage 94 at a second end. As the main adjustment bar is rotated in direction 91, adjusting linkages 94 push rail 62 in direction 95 to increase the width of the closure and exit sections. Referring to FIG. 7, one of second set of adjusting linkages 96 is shown in detail being carried by the main adjustment bar and connected to end flap folding members 70. Connecting arm 93 is affixed to main adjustment bar 92 at a first end and pivotally connected to adjusting linkage 96 at a second end. As the main adjustment bar is rotated in direction 91, adjusting linkages 96 push end flap folding member 70 in direction 95 to adjust the centerline position. As shown in FIG. 5, one of the second set of adjusting linkages is connected to movable taping carriage 80 for adjusting the centerline position of the carriage as is done for end flap folding member 70. As best shown in FIG. 5A, longitudinal movable rail is moved in direction 95 transverse to box conveyance path 30 by first set of adjusting linkages 94 to increase the width of closure section C and exit section E, and end flap folding members 70 and 72 together with movable taping carriage 80 are moved in direction 95 by second set of adjusting linkages 96 to adjust the centerline position of same simultaneously with the width dimension adjusted by first adjusting linkages 94.

Preferably, the end flap folding member 72 is bolted together with movable tape carriage 80 through slots cut in main frame cross members 81. This provides increased rigidity to the overall structure and ensures that the end flap folding member and movable tape carriage move to the centerline position simultaneously.

In a further advantageous embodiment, a lock is provided for maintaining main adjustment bar 92 in a fixed position after rotating bar to adjust the width and centerline positions to accommodate a different box size. Referring to FIG. 6, the lock include a first locking plate 98 fixedly carried on main frame 10 having an alignment hole for receiving a locking pin 97. A second locking plate 99 is affixed to main adjustment bar 92 having a plurality of holes corresponding to an adjustment position for a specific box size. Locking pin 97 is inserted through the alignment hole in first locking plate 98 and engages a chosen hole of second locking plate 99 so that the main adjustment bar is locked in position for a specific box size and cannot be rotated.

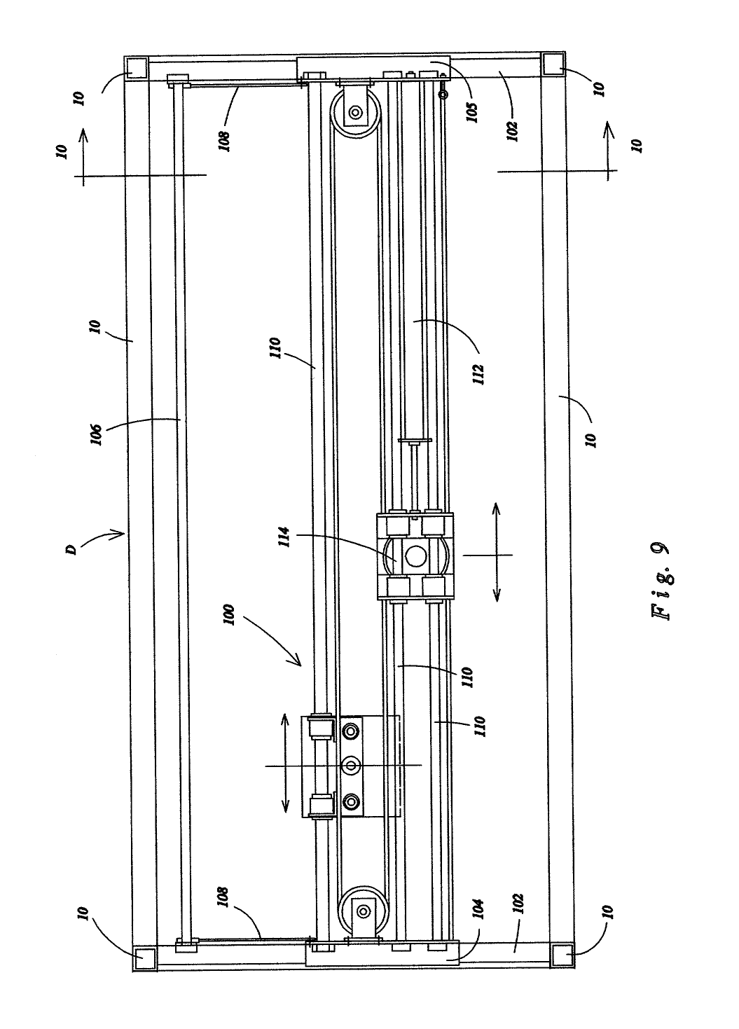

Referring in detail to box conveyor section D, as shown in FIG. 9, the preferred embodiment, includes a pressure foot assembly, designated generally as 100, for applying pressure to the bottom end and bottom side flaps during taping, and which moves the box through the closure section to the exit section. As with the shuttle section and closure section, an adjusting mechanism is operatively associated with the pressure foot assembly for adjusting the pressure foot assembly in conjunction with the closure section and exit section to accommodate folding different box sizes. A pressure foot frame 102 is provided for carrying the pressure foot assembly on main frame 10 above closure section C and exit section E. The box conveyor includes an engaging member for engaging at least one of the bottom end and bottom side flaps during taping. Referring to FIG. 8, as noted above, pressure foot assembly 100 includes a pressure foot 28, which comprises the engaging member, extending into the open box during folding for applying pressure to the inner surface of the bottom end and bottom side flaps. The adjusting mechanism moves the pressure foot when folding different box sizes to apply pressure over the centerline position of the box, which improves contact between tape applicator 78 and the box flaps. The pressure foot assembly includes first and second mounts 104 and 105 slidably carried by pressure foot frame 102 for supporting the pressure foot assembly within the pressure foot frame. Box conveyance path 30 is defined between mounts 104 and 105 along which the pressure foot is moved to convey the open box through the closure section for folding and taping.

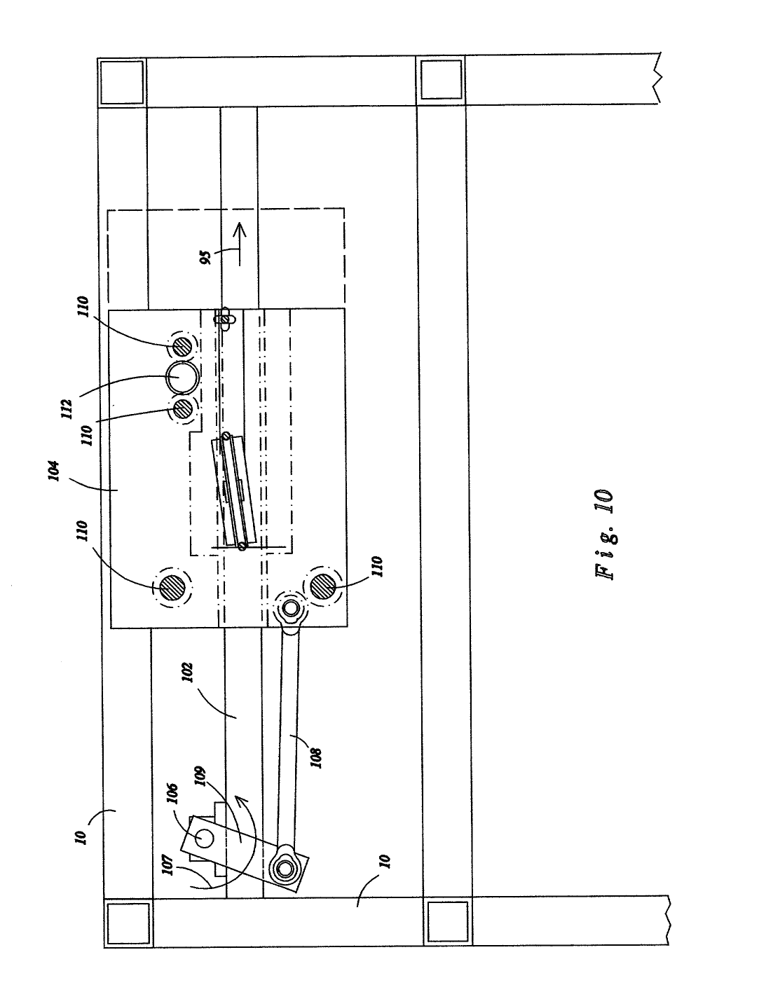

In the preferred embodiment, the adjusting mechanism is connected to first and second mounts 104 and 105 for moving pressure foot assembly 100 transverse the box conveyance path 30 to adjust the position of the pressure foot to the centerline position for a specific box size. The adjusting mechanism for the box conveyor section is basically the same as that used for the closure section. As best shown in FIG. 10, the adjusting mechanism includes a main adjustment bar 106 carried by main frame 10. A set of adjusting linkages 108 is carried by main adjustment bar 106 and connected to first and second mounts 104 and 105. Connecting arm 109 is affixed to main adjustment bar 106 at a first end and pivotally connected to adjusting linkage 108 at a second end so that when the main adjustment bar is rotated in direction 107, the adjusting linkages move pressure foot assembly 100 in transverse direction 95 to position pressure foot 28 at the correct centerline location for different box sizes. As described above, a lock for maintaining the main adjustment bar in a fixed position is proved. Referring to FIG. 9, various guide rods are provided for directing the pressure foot along box conveyance path 30, along with a pneumatic cylinder 112 and pulley system 114 that provides the means for moving the pressure foot between mounts 104 and 105. As best shown in FIG. 8, a pneumatic cylinder 116 is provided for moving raising and lowering pressure foot 28 into the top of the open box.

In operation, an operator picks up a folded box and positions it on tilt table 32 by squaring it with opening arm 48 and flap gauge 38 mounted on the top of the tilt table. These two points position the folded box in a square position within shuttle assembly 16, so that the box is properly aligned for entering the closure section through feed opening 18 and a square and rigid box is produced when it exits through delivery zone 26.

When the folded box contacts vacuum cups lips 46, a vacuum is formed and at a preset point activated arm actuator 54, which extend forcing vacuum cups 50 at the end of the opening arm to make contact with the box. At this point, a vacuum is formed and reaching a preset point causes the opening arm to return, which opens the box into an open rectangular box form.

Once the opening arm is returned, this signals second actuator 36 to retract, positioning the box vertically above the closure section. When the tilt table reaches a vertical position, it signals first actuator 34 to extend, which places the box into the closure section. Once in the closure section, this signals two actions; one to the end flap closure cylinders 73 and one to pressure foot assembly cylinder 112. The end flap closure cylinders extend, rotating end flap closure members 70 and 72 inward and closing the box end flaps. The pressure foot assembly cylinder 112 retracts, positioning the pressure foot over the box in the closure section. Closure of the end flaps activates the side flap folding member cylinders 75, moving the side flap folding members inward and closing the side flaps. Closure of the side flaps signals retraction of the end flap folding member cylinder. This signal also actuates pressure foot cylinder 116 to extend the pressure foot into the bottom of the box. Once the pressure foot is extended, this turns off the vacuum generators and actuates pressure foot assembly cylinder 112 to return, which moves the box across tape applicator 78 taping the bottom flaps and moving the box into the exit section. As the rear end of the box clears movable taping carriage 80, a signal is given to return the side flap folding member cylinders 75 and first actuator 34. Exit cylinder 118 are mounted underneath first and second exit doors and opens the exit doors so the open taped box can drop onto a conveyor system in delivery zone 26. The shuttle assembly reaching a home position, signals the second actuator 36 to extend and position the tilt table at the 45° angle start position. This actuates the vacuum generators for the vacuum cups, making the box erector ready for another cycle.

Preferably, the erector is provided with an emergency stop button. Pressing the “stop” button turns the main air valve “off” which leaves all function in a stopped state. To start again, press the “start” button and load a folded box onto the tilt table, starting the vacuum process, which initiates the closing operation. When a jam occurs, press the “stop” button, clear the jam, and then press and hold the “reset” button. This returns all functions to the home position. The box erector is then ready for a new folded box.

While a preferred embodiment of the invention has been described using specific terms, such description is for illustrative purposes only, and it is to be understood that changes and variations may be made without departing from the spirit or scope of the following claims.

What is claimed is:

1. A box erector for erecting folded boxes of different sizes into open boxes having a rectangular form, each of said open boxes having a pair of spaced apart side panels, a pair of spaced apart end panels, a pair of bottom end flaps, a pair of bottom side flaps, and a pair of top end flaps and a pair of top side flaps, said apparatus comprising:
a main frame including a box entrance zone through which said folded boxes are fed;
a shuttle section carried by said main frame for receiving and unfolding said folded boxes to produce said open boxes ready for closure;
a closure section carried by said main frame for receiving said open boxes from said shuttle section, said closure section having a closure assembly for folding said bottom end flaps and bottom side flaps inward, and a taping assembly for taping said bottom end flaps and bottom side flaps closed to produce completed boxes ready to receive goods;
a box conveyor for moving said open boxes through said closure section and maintaining proper orientation of said boxes during folding and taping;
a box delivery zone for removing said completed boxes for filling; and,
an adjusting mechanism operatively associated with one of said shuttle section, closure section, and box conveyor for adjusting one of said shuttle section, closure section, and box conveyor to accommodate different box sizes proceeding between said entrance and delivery zone;
whereby, an adjustable box erector having a compact design capable of receiving a variety of differently sized boxes is provided that can be utilized as an adjunct to an existing product packaging system.

2. The apparatus of claim 1 wherein said shuttle section includes a shuttle frame carried by said main frame; and a shuttle assembly carried by said shuttle frame for opening said folded boxes and transferring said open boxes to said closure section.

3. The apparatus of claim 2 wherein said shuttle assembly includes a box receiving table, and said adjusting mechanism is operatively associated with said box receiving table to align different box sizes on said box receiving table for opening and transferring said folded boxes to said closure section.

4. The apparatus of claim 3 wherein said box receiving table includes a tilt table for supporting said folded boxes for opening and transfer to said closure section; said tilt table having a box receiving position in which said tilt table is raised vertically along said shuttle frame and tilted for receiving said folded boxes, and a box depositing position in which said tilt table is retracted and lowered along said shuttle frame for delivering said boxes to said closure section; and a shuttle drive operatively associated with said tilt table for moving said tilt table between said box receiving position and said box depositing position.

5. The apparatus of claim 4 wherein said shuttle drive includes a first actuator raising and lowering said tilt table vertically along said shuttle frame for depositing said open boxes in said closure section; and a second actuator tilting and retracting said tilt table to receive said folded boxes.

6. The apparatus of claim 5 wherein said first and second actuators are pneumatic cylinders operable between an extended position where said tilt table is lowered along said shuttle frame and said tilt table is tilted to receive said folded boxes; and a retracted position where said tilt table is raised along said shuttle frame and said tilt table is retracted for lowering along said shuttle frame.

7. The apparatus of claim 3 wherein said adjusting mechanism is carried by said box receiving table for adjusting the position of said folded boxes on the box receiving table depending on the size of the box to be processed, so that the box is properly aligned when lowered into said closure section for folding and taping of said bottom side and bottom end flaps.

8. The apparatus of claim 7 wherein said adjusting mechanism includes a movable flap gauge carried by said box receiving table for aligning said folded boxes on the box receiving table according to the specific box size; and an index carried by said box receiving table for determining proper placement of said flap gauge on said box receiving table to properly position said folded box on said box receiving table.

9. The apparatus of claim 8 wherein said flap gauge includes an elongated bar extending across said box receiving table for abutting edges of the top box flaps; and wherein said index includes indexing elements carried by said box receiving table that correspond to different box sizes; said bar including complementary engagement elements for engaging said indexing elements to correctly position said bar on said box receiving table for a specific box size to be processed.

10. The apparatus of claim 3 including a plurality of retention members carried by said box receiving table for holding said folded boxes firmly against said box receiving table while said folded boxes are opened and transferred into said closure section.

11. The apparatus of claim 10 wherein said retention members provide a suction force against said folded boxes to hold said folded boxes in position for opening and transfer.

12. The apparatus of claim 11 wherein said retention members include vacuum cups carried by said box receiving table providing a suction to hold said folded boxes against said box receiving table; said vacuum cups including a lip portion protruding through openings in said box receiving table and extending slightly above the surface of said box receiving table for holding said folded boxes.

13. The apparatus of claim 10 including an opening arm carried by said box receiving table for engaging said folded boxes and opening said folded boxes.

14. The apparatus of claim 13 wherein said opening arm includes gripping elements grasping said folded boxes for opening; said opening arm having a box gripping position where said gripping elements grasp said folded boxes, and a box opening position where said arm is moved from said gripping position to unfold said folded boxes; and an arm actuator for moving said opening arm between said box gripping position and said box opening position.

15. The apparatus of claim 14 wherein said gripping elements include vacuum cups disposed along a distal end of said opening arm for grasping said folded boxes.

16. The apparatus of claim 14 wherein said arm actuator includes a pneumatic cylinder operable between an extended position where said opening arm is moved to said box gripping position, and a retracted position where said opening arm is moved to unfold said folded boxes.

17. The apparatus of claim 1 wherein said closure section includes a closure frame carried by said main frame and a taping frame carried by said main frame; and said adjusting mechanism operatively associated with said closure frame and taping frame for adjusting the width of said closure and taping frames according to the size of box being processed.

18. The apparatus of claim 17 wherein said closure and taping frames include a longitudinal movable rail operatively associated with said adjusting mechanism; and a—box conveyance path along which the box is moved through the closure section for flap folding and taping; said rail being disposed parallel to said conveyance path and moveable transverse to said conveyance path by said adjusting mechanism to adjust the width of said closure and taping frames for accommodating different box sizes.

19. The apparatus of claim 18 wherein said longitudinal movable rail extends through said closure and taping frames to adjust the width of said closure and taping assemblies simultaneously for a specific box size to be processed.

20. The apparatus of claim 19 wherein said closure assembly includes end flap folding members for closing said bottom end flaps, and side flap folding members for closing said bottom side flaps; a first of said side flap folding members being affixed to said closure frame, and a second of said side flap folding members being carried by said longitudinal movable rail to adjust the width between said first and second side flap folding members to accommodate closing flaps of different box sizes; and said end flap folding members being simultaneously moved by said adjusting mechanism to a centerline position along which the bottom side flaps of a specific box size are taped closed.

21. The apparatus of claim 20 wherein said taping assembly includes a tape applicator carried by a movable taping carriage for taping said bottom end and bottom side flaps closed; said taping carriage being moveable by said adjusting mechanism to adjust the centerline position of the taping carriage for taping along a centerline for a specific box size when the width of said taping assembly is adjusted to process a different box sizes; fixed guide rollers being carried by said taping frame for engaging a first of said side panels of said box to guide the box though the taping assembly, and movable guide rollers engaging a second of said side panels being carried by said longitudinal movable rail for adjusting the width between said fixed and movable guide rollers to accommodate different box sizes.

22. The apparatus of claim 21 including an exit section carried by said main frame following said closure section; said exit section including an exit frame carrying an exit assembly; said exit assembly holding said completed box in an upright orientation before entering said delivery zone; said longitudinal movable rail extending through said exit frame for adjusting the width of said exit frame concurrently with said closure and taping frames.

23. The apparatus of claim 22 wherein said exit assembly includes a first exit door affixed to said exit frame, and a second movable exit door carried by said longitudinal movable rail for adjusting the width of said exit assembly to allow different box sized to pass through said exit assembly; said first and second exit doors moving to allow said completed box to pass from said exit assembly to said delivery zone where the box is ready to be filled.

24. The apparatus of claim 23 wherein said adjusting mechanism includes a main adjustment bar carried by said main frame; a first set of adjusting linkages carried by said main adjustment bar being connected to said longitudinal movable rail for moving said longitudinal movable rail to adjust the width of said closure frame, taping frame, and exit frame; and a second set of adjusting linkages carried by said main adjustment bar being connected to said end flap folding members and said movable taping carriage for adjusting the centerline position of same to accommodate folding and taping different box sizes.

25. The apparatus of claim 24 wherein said first set of adjusting linkages moves at a two to one ratio to said second set of adjusting linkages.

26. The apparatus of claim 24 including a lock for maintaining said main adjustment bar in a fixed position after rotating said bar to adjust the width of said closure frame, taping frame, and exit frame and the centerline position of said end flap folding members and said movable taping carriage to accommodate different box sizes.

27. The apparatus of claim 26 wherein said lock include a first locking plate fixedly carried by said main frame having an alignment hole for receiving a locking pin; a second locking plate carried by said main adjustment bar having a plurality of holes corresponding to an adjustment position for a specific box size; said locking pin being inserted through said alignment hole in said first locking plate and engaging a chosen hole of said second locking plate so that said main adjustment bar is locked in position for a specific box size and cannot be rotated.

28. The apparatus of claim 1 wherein said box conveyor includes a pressure foot assembly for applying pressure to said bottom end and bottom side flaps during taping; said adjusting mechanism being operatively associated with said pressure foot assembly for adjusting the pressure foot assembly in conjunction with said closure section to accommodate folding different box sizes.

29. The apparatus of claim 28 including a pressure foot frame carrying said pressure foot assembly on said main frame above said closure section; wherein said pressure foot assembly includes a pressure foot extending into said open box during folding by said closure assembly for applying pressure to the inner surface of said bottom end and bottom side flaps; and said adjusting mechanism being operatively associated with said pressure foot for moving said pressure foot when folding different box sizes to apply pressure over a centerline position along which the box is taped.

30. The apparatus of claim 29 wherein said pressure foot assembly includes first and second mounts slidably carried by said pressure foot frame for supporting said pressure foot assembly within said pressure foot frame; and a box conveyance path defined between said mounts along which said pressure foot moves said open box through said closure section for folding and taping.

31. The apparatus of claim 30 wherein said adjusting mechanism is connected to said first and second mounts for moving said pressure foot assembly transverse to said box conveyance path to adjust the position of said pressure foot to said centerline position for a specific box size.

32. The apparatus of claim 31 wherein said adjusting mechanism includes a main adjustment bar carried by said main frame; a set of adjusting linkages carried by said main adjustment bar being connected to said first and second mounts so that when said main adjustment bar is rotated, said adjusting linkages move said pressure foot assembly in said transverse direction to position said pressure foot at the correct centerline location for different box sizes.

33. The apparatus of claim 32 including a lock for maintaining said main adjustment bar in a fixed position after rotating said bar to adjust said centerline position of said pressure foot for a different box size.

34. The apparatus of claim 33 wherein said lock includes a first locking plate carried by said main frame having an alignment hole for receiving a locking pin; a second locking plate carried by said main adjustment bar having a plurality of holes corresponding to an adjustment position for a specific box size; said locking pin being inserted through said alignment hole in said first locking plate and engaging a chosen hole of said second locking plate so that said main adjustment bar is locked in position for a specific box size and cannot be rotated.

35. A box erector for erecting folded boxes of different sizes into open boxes having a rectangular form, each of said open boxes having a pair of side panels and a pair of end panels, a pair of bottom end flaps and bottom side flaps, and a pair of top end flaps and top side flaps, said box erector being of the type having a closure section and an exit section, wherein a feed opening is provided for said folded boxes at said closure section and a delivery zone is provided at said exit section for delivering complete boxes, said box erector comprising:
a main frame on which said closure section and exit section are carried;
a shuttle section carried adjacent said feed opening of said closure section for receiving and opening said folded boxes; said shuttle section including a shuttle frame carried by said main frame;
a shuttle assembly carried by said shuttle frame for opening said folded boxes to produce said open boxes having a rectangular form, and transferring said open boxes into said closure section at said feeding zone;
said shuttle assembly including a box receiving table for supporting said folded boxes during opening and transfer to said closure section; and
a shuttle adjusting mechanism for controlling the position of said folded boxes on said box receiving table according to the size of box being processed;
whereby, an adjustable box erector capable of receiving a variety of differently sized boxes is provided that can be utilized as an adjunct to an existing product packaging system.

36. The apparatus of claim 35 wherein said box receiving table includes a tilt table for supporting said folded box for opening and transfer to said closure section; said tilt table having a box receiving position in which said tilt table is raised vertically along said shuttle frame and tilted for receiving said folded boxes, and a box depositing position in which said tilt table is retracted and lowered along said shuttle frame for delivering said boxes to said closure section; and a shuttle drive operatively associated with said tilt table for moving said tilt table between said box receiving position and said box depositing position.

37. The apparatus of claim 36 wherein said shuttle drive includes a first actuator raising and lowering said tilt table vertically along said shuttle frame for depositing said open boxes in said closure section; and a second actuator tilting and retracting said tilt table to receive said folded boxes.

38. The apparatus of claim 36 wherein said shuttle adjusting mechanism includes a gauge carried by said box receiving table for aligning said folded boxes on the box receiving table according to the specific box size; said box receiving table including an index for determining proper placement of said gauge on said box receiving table to properly position said folded box on said box receiving table.

39. The apparatus of claim 38 wherein said gauge includes an elongated bar extending across said box receiving table for abutting edges of the top box flaps; and wherein said index includes first indexing elements carried by said box receiving table that correspond to different box sizes; said bar including complementary engagement elements for engaging said indexing elements to correctly position said bar on said box receiving table for a specific box size to be processed.

40. The apparatus of claim 36 including a plurality of retention members carried by said box receiving table for holding said folded boxes firmly against said box receiving table while said folded boxes are opened and transferred into said closure section.

41. The apparatus of claim 40 including an opening arm carried by said box receiving table for engaging said folded boxes and opening said folded boxes.

42. The apparatus of claim 41 wherein said opening arm includes gripping elements grasping said folded boxes for opening; said opening arm having a box gripping position where said gripping elements grasp said folded boxes, and a box opening position where said arm is moved from said gripping position to unfold said folded boxes; and an arm actuator for moving said opening arm between said box gripping position and said box opening position.

43. A box erector for erecting folded boxes of different sizes into open boxes having a rectangular form, each of said open boxes having a pair of side panels and a pair of end panels, a pair of bottom end flaps and bottom side flaps, and a pair of top end flaps and top side flaps, said box erector being of the type having a closure section and an exit section, wherein a feed opening is provided at said closure section and a delivery zone is provided at said exit section, said box erector comprising:
a main frame;
a closure frame of said closure section carried by said main frame;
a taping frame of said closure section carried by said main frame;
an exit frame of said exit section carried by said main frame;
an adjustable shuttle assembly carried by said main frame adjacent said closure section for receiving said folded boxes; said shuttle assembly opening said folded boxes into said open boxes and transferring said open boxes to the closure frame at said feed opening;
said shuttle assembly including a box receiving table being adjustable to align different box sizes on said box receiving table for feeding to said closure frame;
said closure frame receiving said open boxes for closing said bottom side and end flaps to produce open boxes with closed bottom flaps;
said taping frame receiving said open boxes with closed bottom flaps for taping said bottom flaps to produce completed taped boxes having closed, taped, bottom flaps;
said exit frame receiving said completed taped boxes and delivering said boxes to said delivery zone where the boxes are ready for filling;
said closure frame including an adjustable closure frame member;
said taping frame including an adjustable taping frame member;
said exit frame including an adjustable exit frame member;
a box size adjusting mechanism for adjusting the adjustable closure frame member, taping frame member, and exit frame member according to the box size being processed;
whereby, an adjustable box erector capable of receiving a variety of differently sized boxes is provided that can be utilized as an adjunct to an existing product packaging system.

44. The apparatus of claim 43 wherein said box receiving table includes a tilt table for supporting said folded boxes for opening and transfer to said closure frame; said tilt table having a box receiving position in which said tilt table is raised vertically along said shuttle frame and tilted for receiving said folded boxes, and a box depositing position in which said tilt table is retracted and lowered along said shuttle frame for delivering said boxes to said closure frame; and a shuttle drive operatively associated with said tilt table for moving said tilt table between said box receiving position and said box depositing position.

45. The apparatus of claim 44 wherein said shuttle drive includes a first actuator raising and lowering said tilt table vertically along said shuttle frame for depositing said open boxes in said closure frame; and a second actuator tilting and retracting said tilt table to receive said folded boxes.

46. The apparatus of claim 43 wherein said closure frame, taping frame and exit frame are sequentially aligned along a longitudinal conveyance path of said open boxes during processing.

47. The apparatus of claim 46 wherein said adjustable closure frame member, said adjustable taping frame member and adjustable exit frame member are provided by a common adjustable longitudinal rail which extends along a common side of said closure frame, taping frame and exit frame; said adjustable longitudinal rail operatively associated with said box size adjusting mechanism to adjust the width of said closure frame, taping frame and exit frame to a specific box size being processed.

48. The apparatus of claim 47 wherein said adjusting mechanism includes a main adjustment bar carried by said main frame; a first set of adjusting linkages carried by said main adjustment bar being connected to said longitudinal movable rail for moving said longitudinal movable rail to adjust the width of said closure frame, taping frame, and exit frame.

49. The apparatus of claim 48 wherein said closure frame includes end flap folding members for closing said bottom end flaps; said taping frame including a tape applicator carried by a movable taping carriage for taping said bottom end and bottom side flaps closed after folding; and a second set of adjusting linkages carried by said main adjustment bar being connected to said end flap folding members and said movable taping carriage for adjusting the centerline position of same to accommodate folding and taping different box sizes.

50. The apparatus of claim 49 wherein said first set of adjusting linkages moves at a two to one ratio to said second set of adjusting linkages.

51. The apparatus of claim 43 including a box conveyor for moving said open boxes through said closure frame, taping frame and exit frame, and maintaining proper orientation of said boxes during folding and taping.

52. The apparatus of claim 51 wherein said box conveyor includes an engaging member for engaging at least one of said bottom end and bottom side flaps during taping; said adjusting mechanism being operatively associated with said engaging member for adjusting the position of said engaging member in conjunction with said closure section to accommodate closing and taping different box sizes.

53. The apparatus of claim 52 including a pressure foot assembly which includes a pressure foot that constitutes said engaging member; said pressure foot extending into said open boxes during folding by said closure section for applying pressure to the inner surface of said bottom end and bottom side flaps; said pressure foot assembly being carried on a pressure foot frame which is carried above said closure section; and said adjusting mechanism being operatively associated with said pressure foot for moving said pressure foot when folding different box sizes to apply pressure over a centerline position along which the boxes are taped.

54. The apparatus of claim 53 wherein said pressure foot assembly includes first and second mounts slidably carried by said pressure foot frame for supporting said pressure foot assembly within said pressure foot frame; and a box conveyance path defined between said mounts along which said pressure foot moves said open boxes through said closure frame, taping frame and exit frame.

55. The apparatus of claim 54 wherein said adjusting mechanism is connected to said first and second mounts for moving said pressure foot assembly transverse to said box conveyance path to adjust the position of said pressure foot to said centerline position for a specific box size.

56. The apparatus of claim 55 wherein said adjusting mechanism includes a main adjustment bar carried by said main frame; a set of adjusting linkages carried by said main adjustment bar being connected to said first and second mounts so that when said main adjustment bar is rotated, said adjusting linkages move said pressure foot assembly in said transverse direction to position said pressure foot at the correct centerline location for different box sizes.
